(19) United States
(12) Patent Application Publication
(10) Pub. No.: US 2025/0258765 A1
(43) Pub. Date: Aug. 14, 2025

(54) MANAGING METADATA ASSOCIATED WITH MEMORY ACCESS OPERATIONS IN A MEMORY DEVICE

(71) Applicant: Micron Technology, Inc., Boise, ID (US)

(72) Inventors: David Roberts, Wellesley, MA (US); John M. Groves, Austin, TX (US)

(21) Appl. No.: 19/041,569

(22) Filed: Jan. 30, 2025

Related U.S. Application Data
(60) Provisional application No. 63/552,840, filed on Feb. 13, 2024.

(51) Int. Cl. G06F 12/02

(52) U.S. Cl. CPC G06F 12/0223

(57) ABSTRACT

A system includes a plurality of memory devices and a processing device operatively coupled with the plurality of memory devices, to perform operations including: receiving a request to perform a memory access operation at a first memory region of a first memory device; determining, based on a data structure referencing a namespace, a mapping between an identifier of the first memory region and an identifier of a metadata region associated with the first memory region; identifying, based on an operation type of the memory access operation, one or more corresponding actions associated with the metadata region; and, responsive to causing the memory access operation to be performed on a first plurality of memory cells at the first memory device, causing at least one of the one or more corresponding actions to be performed on a second plurality of memory cells corresponding to the metadata region.

### REFERENCE TO RELATED APPLICATION

This application claims the priority benefit of U.S. Provisional Patent Application No. 63/552,840, filed Feb. 13, 2024, the entirety of which is incorporated herein by reference.

### TECHNICAL FIELD

Embodiments of the disclosure relate generally to memory sub-systems, and more specifically, relate to managing metadata associated with memory access operations in a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure;

FIG. 2 is a block diagram of an example system for managing the performance of input/output (I/O) operations associated with a memory device, in accordance with some embodiments of the present disclosure.

FIG. 3 illustrates an example data structure referencing a namespace accessible to a host system and a plurality of dynamic capacity devices, in accordance with some embodiments of the present disclosure.

FIG. 4 is a flow diagram of an example method for managing metadata associated with memory access operations in a memory device, in accordance with some embodiments of the present disclosure.

FIG. 5 is a block diagram of an example computer system in which embodiments of the present disclosure may operate.

### DETAILED DESCRIPTION

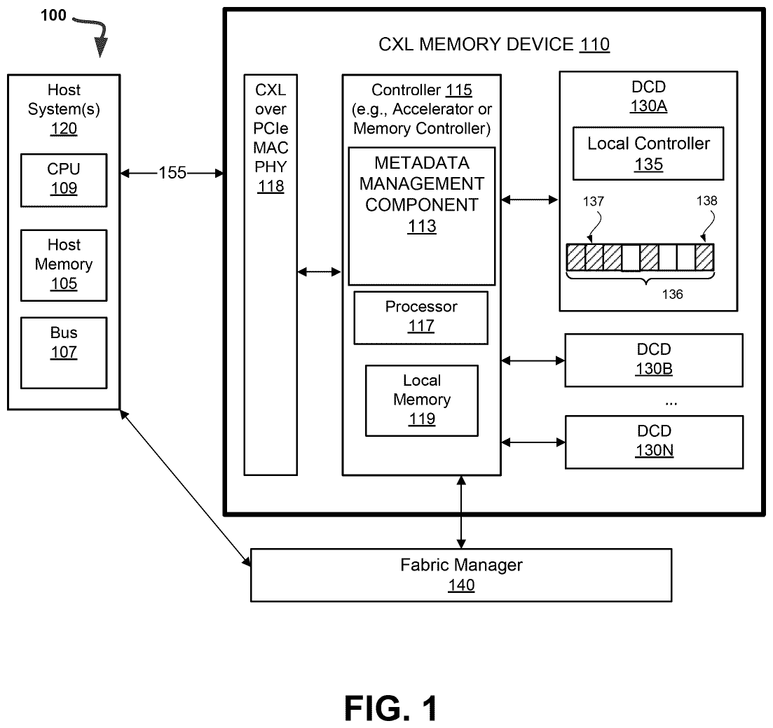

Aspects of the present disclosure are directed to managing metadata associated with memory access operations in a memory device, e.g., a compute express link (CXL) memory device. A memory sub-system can be a storage device, a memory module, or a combination of a storage device and a memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is a cache-coherent interconnect for processors, memory expansion, and accelerators. A CXL system maintains memory coherency between a central processing unit (CPU) memory space and memory on memory-attached devices, which allows for resource sharing for higher performance, reduced software stack complexity, and a lower overall system cost. Generally, CXL is an interface standard that can support a number of protocols that can run on top of a Peripheral Component Interconnect Express (PCIe), including a CXL.io protocol, a CXL.mem protocol, and a CXL.cache protocol. PCIe is an interface standard used for connecting various hardware components, primarily in high-performance computing systems. The CXL.io protocol is a PCIe-like protocol that can be viewed as an “enhanced” PCIe protocol that is capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., Non-Volatile Memory Express (NVMe) traffic) can run through the CXL.io protocol. The CXL.mem and CXL.cache protocols can share a common link layer and transaction layer. Accordingly, the CXL protocols can be multiplexed and transported via a PCIe physical layer.

A memory device that is attached to a host (e.g., a host device, etc.) via a CXL interface can be referred to as a CXL memory device, which can provide additional device bandwidth and capacity to host processors. The CXL memory device is independent of the host device. In some implementations, the CXL memory device can partition memory resources into multiple logical devices (also referred to herein as “dynamic capacity devices”), and each logical device can be visible as a memory device. In some implementations, the CXL memory device can serve multiple host systems. A dynamic capacity device (DCD) is a CXL memory device that implements dynamic capacity (DC). DC is a feature of a CXL memory device that allows memory capacity to change dynamically without the need for resetting the CXL memory device, such that memory capacity allocated to one or more host devices can be changed (e.g., added or released) at runtime.

In some implementations, certain aspects of the CXL memory device can be managed by a separate entity (e.g., an external logical process) referred to as a fabric manager (also referred to herein as a “fabric management component”). In some embodiments, the fabric manager can be software running on a host system, firmware embedded within a Baseboard Management Controller (BMC) of a distributed application, or a dedicated device running in a CXL device. The fabric manager can subdivide a device physical address (DPA) range of a DCD into several memory regions (e.g., 1 to 8 regions). The fabric manager can further subdivide each of these memory regions into a set of blocks. The fabric manager can allocate each block to a host system, and the fabric manager can associate each block with an identifier (also referred to as a “tag”). Each block can be referred to as a taggable DC unit. The taggable DC unit can represent a management unit that can be tagged (e.g., associated with an identifier or “tag”), assigned to various capacity sizes, and dynamically allocated to various host systems. Each identifier is globally unique, and thus the identifiers associated with the taggable DC units can form an aggregate tag space (also referred to as a “namespace”) in the CXL memory device. The aggregate tag space can be associated with a mapping data structure that includes an entry for each identifier, where each entry maps an identifier to one or more associated host systems. Each identifier can also be mapped to one or more DPA ranges (e.g., a set of one or more contiguous physical address ranges or non-contiguous physical address ranges that identify respective locations storing data on the DCDs). The one or more DPA ranges mapped to an identifier can be shareable or not among the one or more host systems, such that each of the one or more host systems can access data stored at the one or more DPA ranges or be restricted from accessing the data stored at the one or more DPA ranges. Each entry of the mapping data structure can also include a field that includes a pointer to a taggable DC unit's metadata on the DCD. Specifically, the pointer can reference the physical location (e.g., a physical address range) of a metadata region associated with the one or more DPA ranges. The metadata region can be a read-only (e.g., read-only to a host system) portion of a DCD, where the metadata region includes metadata stored in one or more memory regions of the DCD. For example, the metadata can include heat maps, temporal prefetch history, and other statistics of the data stored in the one or more memory regions (e.g., metadata associated with the identifier of the taggable DC unit, where the identifier is mapped to the one or more DPA ranges).

As described above, certain aspects of the CXL memory device can be managed by a fabric manager (also referred to herein as a “fabric management component”). The fabric manager can configure resource allocation for multiple host systems across the logical devices. For some DCDs, the fabric manager controls the allocation of these taggable DC units to one or more host systems (or a group of host systems) and utilizes events (e.g., notifications, interrupts, etc.) to signal to the host systems when changes to the allocation of these taggable DC units occur. The fabric manager also assigns an identifier to an allocated taggable DC unit by associating, in a mapping data structure, the identifier of a taggable DC unit with one or more physical address ranges (e.g., DPA ranges). The DCD can map these DPA ranges to corresponding virtual address ranges within a virtual address space of the host system. The DCD implements a set of commands for querying and configuring taggable DC units. The set of commands can include a command allocating new taggable DC units (e.g., add dynamic capacity response command), a command releasing the taggable DC units (e.g., release dynamic capacity command), and a command getting information related to the taggable DC units. The capacity of a taggable DC unit associated with an identifier and allocated to a host system is immutable such that no additional capacity can be added to the taggable DC unit, nor can some capacity be deleted from the taggable DC unit. Further, although the content stored in a taggable DC unit can be modified, the mapping between the identifier of the taggable DC unit and a host system cannot be modified by the DCD. If a taggable DC unit is not shareable among one or more host systems, the mapping between the identifier of the DC unit and a host system can be modified by the DCD.

In some implementations, a host system can send a request to perform a memory access operation to a DCD and/or a fabric manager. The memory access operation can be a write operation and/or a read operation. The request can specify a memory region of a dynamic capacity device at which to perform the memory access operation. Processing logic (e.g., the fabric manager) can look up, using the mapping data structure, a range of physical addresses within the memory region of the dynamic capacity device corresponding to the memory region specified by the request. The data structure can include a set of entries, such that each entry includes a mapping between an identifier of the dynamic capacity device and the corresponding range of physical addresses within the memory region of the dynamic capacity device. The memory access operation can be performed on a set of memory cells that are addressable by the identified range of physical addresses within the memory region of the dynamic capacity device. Typically, metadata that is associated with data at the corresponding range of physical addresses within the memory region may be lost when a memory access operation is performed on the set of memory cells that are addressable at the identified range of physical addresses within the memory region. For example, the data can be moved to another range of physical addresses within the memory region and/or to another memory region. In another example, the data can be duplicated at another range of physical addresses within the memory region and/or another memory region. In such cases, important information stored in the metadata may not be likewise moved and/or duplicated along with its associated data because the metadata is typically stored in a separate region (e.g., a metadata region) of the dynamic capacity device. Thus, the metadata stored in the separate region of the dynamic capacity device may not be moved and/or duplicated along with its associated data.

Aspects of the present disclosure address the above and other deficiencies by a fabric manager that manages updates to metadata associated with memory access operations in a memory device, e.g., a compute express link (CXL) memory device. For example, in some embodiments, a host system can send a request (e.g., to a fabric manager) to perform a memory access operation (e.g., a read operation and/or write operation) at a particular memory region of a DCD. The request can include an identifier of the particular memory region of the DCD. In some embodiments, in response to receiving the request, processing logic (e.g., the fabric manager) can identify a mapping between the identifier of the particular memory region and an identifier of a metadata region associated with the particular memory region. The mapping can be identified using a data structure (e.g., a mapping data structure) that references a namespace that is accessible to the host system and the DCD. For example, the data structure can include a set of entries, where each entry can include an identifier of a memory region, a pointer referencing a physical location of a metadata region associated with the memory region, an identifier of a corresponding range of physical addresses of a set of DCDs, an identifier of one or more host systems of a set of host systems, where the memory region is accessible by the one or more host systems. In some embodiments, the fabric manager can identify, based on the operation type of the memory access operation, one or more actions to perform with respect to the metadata region. For example, the operation type can include a read operation, a write operation, etc. Identifying the one or more actions to perform can include identifying a mapping between the operation type and the one or more actions, where the mapping is stored in an entry of a data structure (e.g., the aforementioned mapping data structure). For example, an operation type that is a “read operation” can be mapped to at least the following one or more actions: a move operation to move metadata of a metadata region from a first physical location to a second physical location, a copy operation to copy at least a portion of the metadata of the metadata region to another physical location, a reset operation to reset at least a portion of the metadata of the metadata region, a clone operation to duplicate at least a portion of the metadata of the metadata region, etc. In another example, an operation type that is a “write operation” can be mapped to at least the following one or more actions: a move operation to move metadata of a metadata region from a first physical location to a second physical location, a copy operation to copy at least a portion of the metadata of the metadata region to another physical location, a reset operation to reset at least a portion of the metadata of the metadata region, a clone operation to duplicate at least a portion of the metadata of the metadata region, a computation operation to perform a computation operation on at least a portion of the metadata of the metadata region. The computation operation can be any computation operation. For example, the computation operation can include an additive operation, a division operation, a multiplication operation, etc. In some embodiments, in response to identifying the one or more actions, the fabric manager can cause at least one of the one or more actions to be performed on a set of memory cells that are addressable by a physical address corresponding to the metadata region.

Advantages of the present disclosure include preserving critical and important metadata associated with data when memory access operations are performed on the data. As described above, metadata associated with data can include heat maps, temporal prefetch history, and other statistics of the data, which can be used for performance optimization of a memory device. By enabling metadata to persist across memory access operations that might move, copy, or otherwise affect data, there can be an improvement in the performance of memory devices. These and other features of the embodiments of the present disclosure are described in more detail with reference to FIG. 1.

FIG. 1 illustrates a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize an NVM Express (NVMe) interface to access components of the CXL memory device 110 when the CXL memory device 110 is coupled with the host system 120 by the physical host interface (e.g., PCIe bus). FIG. 1 illustrates a CXL memory device 110 as an example. In general, the host system 120 can access multiple CXL memory device 110 via a same communication connection, multiple separate communication connections, and/or a combination of communication connections. The interface can be represented by the CXL interface.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 can include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 can be a cache-coherent interconnect for processors, memory expansion, and accelerators. The computing system 100 maintains memory coherency between the CPU memory space and memory on memory-attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use as a memory buffer for memory bandwidth expansion, memory capacity expansion, and persistent memory applications, and as small-scale resource pooling and large-scale resource pooling and sharing.

In some implementations, the CXL memory device can partition memory resources into multiple logical devices, and each logical device can be visible as a memory device. One of the multiple logical devices can be reserved for a fabric manager to configure resource allocation across the logical devices, while the other logical devices can be available for assigning to the host. In some implementations, the CXL memory device can be a device that supports multiple host systems and can be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application-specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control the operation of the CXL memory device 110, including handling communications between the CXL memory device 110 and the host system 120. The CXL memory device controller 115 can manage operations of CXL memory device 110, such as writes to and reads from DCD 130A-130N. The CXL memory device controller 115 can include one or more processors 117, which can be multi-core processors. Processors 117 can handle or interact with the components of DCD 130A-130N, generally through firmware code. The CXL memory device controller 115 can operate under CXL protocol, but other protocols are applicable.

The CXL memory device controller 115 executes computer-readable program code (e.g., software or firmware) executable instructions (herein referred to as “instructions”). The instructions can be executed by various components of CXL memory device controller 115, such as processor 117, logic gates, switches, application-specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 can be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 can interact with DCD 130A-130N for read and write operations. The CXL memory device controller 115 can execute the direct memory access (DMA) for data transfers between host system 120 and DCD 130A-130N without involvement from CPU 109. The CXL memory device controller 115 can control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations, including memory access commands (e.g., read commands, write commands, etc.) from the host system 120 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a DCD 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140. The fabric manager 140 can be external to each of the DCDs 130A-130N and/or the host system 120. The fabric manager 140 can query and configure the operational state of the computing system 110. In some embodiments, the fabric manager 140 can configure a shared access between a memory region of a DCD of the DCDs 130A-130N and the host system 120. In some embodiments, the fabric manager 140 can configure an access privilege by the host system 120 to a memory region of a DCD of the DCDs 130A-130N. In some embodiments, the fabric manager 140 can be software running on the host system 120, firmware embedded within a Baseboard Management Controller (BMC) of a distributed application, or a dedicated device running in the CXL device. The fabric manager 140 can assign a (logical) device (e.g., DCDs 130A-130N) to the host system 120 by using command sets through the Component Command Interface (CCI). CCI can be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 can assign one taggable DC unit to the host system 120 and create a globally unique identifier attached to the taggable DC unit as a tagged capacity unit 137; the fabric manager 140 can assign another taggable DC unit to the host system 120 and create a globally unique identifier attached to the taggable DC unit as a tagged capacity unit 138. In some implementations, some or all of the functionality of the fabric manager 140 can be performed by the controller 115 and/or a metadata management component 113.

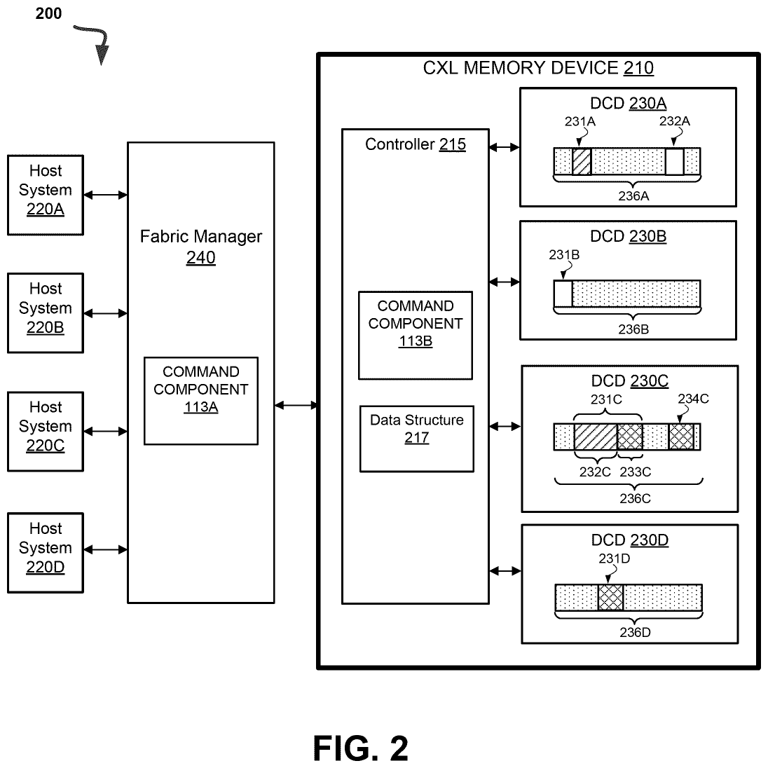

In some embodiments, the CXL memory device 110 includes the metadata management component 113 that enables the host system 120 to perform an operation (e.g., a write operation or read operation). In some embodiments, the CXL memory device controller 115 includes at least a portion of the metadata management component 113. In some embodiments, the metadata management component 113 is part of the host system 120, an application, or an operating system. In other embodiments, local media controller 135 includes at least a portion of the metadata management component 113 and is configured to perform the functionality described herein. Further details regarding the operations of the metadata management component 113 are described below with reference to FIGS. 2-5. In some implementations, the metadata management component 113 includes a command component 113A and a command component 113B as shown in FIG. 2, which can operate together to perform the functionality of the metadata management component 113. In some implementations, some or all of the functionalities of the metadata management component 113 can be performed by the fabric manager 240, the controller 215, the command component 113A, the command component 113B, and/or the combination thereof, as shown in FIG. 2.

In some embodiments, the metadata management component 113 can receive, from a host system (e.g., a host system 220A-N), a request to perform a memory access operation (e.g., a write operation and/or read operation). The request can specify a memory region of a dynamic capacity device at which to perform the I/O operation. The metadata management component 113 can determine, using a data structure (e.g., a mapping data structure) that references the namespace that is accessible to the host system and the dynamic capacity device, a mapping between an identifier of the memory region and an identifier of a metadata region associated with the particular memory region. The metadata management component 113 can identify, based on an operation type of the memory access operation, one or more actions to perform with respect to the metadata region. The metadata management component 113 can cause at least one of the one or more actions to be performed on a set of memory cells that are addressable by a physical address corresponding to the metadata region.

It will be appreciated by those skilled in the art that additional circuitry and signals can be provided, and that the components of FIG. 1 have been simplified. It should be recognized that the functionality of the various block components described with reference to FIG. 1 may not necessarily be segregated into distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a block diagram of an example system for managing metadata associated with memory access operations in a memory device (e.g., a compute express link (CXL) memory device), in accordance with some embodiments of the present disclosure. In various embodiments, the system 200 includes one or more host systems 220A-D (such as the host system 120), a CXL memory device 210 (such as the CXL memory device 110) that includes a controller 215 (e.g., controller 115), and a fabric manager 240. In some embodiments, aspects (to include hardware and/or firmware functionality) of the controller 215 are included in the processing logic of DCDs 230A-230D.

In the example of FIG. 2, the DCD 230A can include a first region 236A, the DCD 230B can include a second region 236B, the DCD 230C can include a third region 236C, and the DCD 230D can include a fourth region 236D. As shown in FIG. 2, each region of the first region 236A, second region 236B, third region 236C, and fourth region 236D can include eight taggable dynamic capacity units, and each taggable dynamic capacity unit can be of a uniform capacity size. Although a specific number of taggable dynamic capacity units is shown in FIG. 2 and taggable dynamic capacity units shown in FIG. 2 have the same capacity size, various capacity sizes can be allocated to the taggable dynamic capacity units according to the request of the host systems, and the number of taggable dynamic capacity units included in a DCD can vary. In some implementations, the capacity size of a taggable dynamic capacity unit can be a multiple of a minimum capacity size, and the minimum capacity size can be 2 MB, 0.5 GB, 1 GB, etc.

In some embodiments, the host systems 220A-D, through the fabric manager 240, can request allocation of tagged capacity in DCDs 230A-230D. For example, a host system 220A can send, to the command component 113A of the fabric manager 240, a request for allocation of tagged capacity in DCDs 230A-230D, where the request can specify a capacity size. The DCDs 230A-230D can be connected to the fabric manager 240 via a compute express link (CXL) interface utilizing the high-speed bus (e.g., a Peripheral Component Interconnect Express (PCIe) bus). The compute express link (CXL) interface can provide an interface that can support several protocols that can run on top of PCIe, including a CXL.io protocol, a CXL.mem protocol, and a CXL.cache protocol.

In some embodiments, for initial allocation of tagged capacity, the fabric manager 240 can determine the portions of the DCDs 230A-230D for allocation. In some implementations, the fabric manager 240 can determine an available portion, in the capacity size requested by the host system 220A, of the DCDs 230A-230D to be allocated to the host system 220A. The fabric manager 240 can provide an identifier of the portions of the DCDs 230A-230D to the controller 215 of the CXL memory device 210. The controller 215 can assign the identifier to the allocated portion referred to as the tagged capacity unit, for example, the tagged capacity unit 231A, or the tagged capacity unit 231C. In some implementations, the fabric manager 240 can determine an available portion, in the requested capacity size, of the DCDs 230A-230D to be allocated to the host system 220A and assign an identifier to the allocated portion referred to as the tagged capacity unit, for example, the tagged capacity unit 231A, or the tagged capacity unit 231C. In various implementations, the identifier is created by the fabric manager 240 so that the identifier is globally unique. The controller 215 can store, in the data structure 217, the identifier, the DPA ranges of the allocated portions of the DCDs 230A-230D, and the host identifier that defines the host system that can access the identifier.

Upon the initial allocation of the tagged capacity unit, the host system 220A-220D can write data to the tagged capacity unit. For example, upon the initial allocation of the tagged capacity unit 231A to the host system 220A, the controller 215 can receive, from host system 220A, data to write to the tagged capacity unit. The controller 215 can store the data in the tagged capacity unit 231A. In some embodiments, storing the data can include the controller 215 writing the data to the tagged capacity unit 231A. In some embodiments, storing the data can further include the controller 215 mapping one or more DPA ranges identifying respective physical locations at which the data resides on the CXL memory device 210 with corresponding virtual address ranges in the virtual address space available to the host system 220C. In some embodiments, the controller 215 can receive, from the host system 220A, a request to allocate a number of bytes to a metadata region associated with the tagged capacity unit 231A. In some embodiments, the controller 215 can store metadata associated with the tagged capacity unit at the metadata region. In some embodiments, the controller 215 can maintain separate metadata for each tagged capacity unit, such that the metadata can be portable, protected, and associated with the tagged capacity unit. In some embodiments, the metadata can include heat maps, temporal prefetch history, and other statistics of the tagged capacity unit 231A.

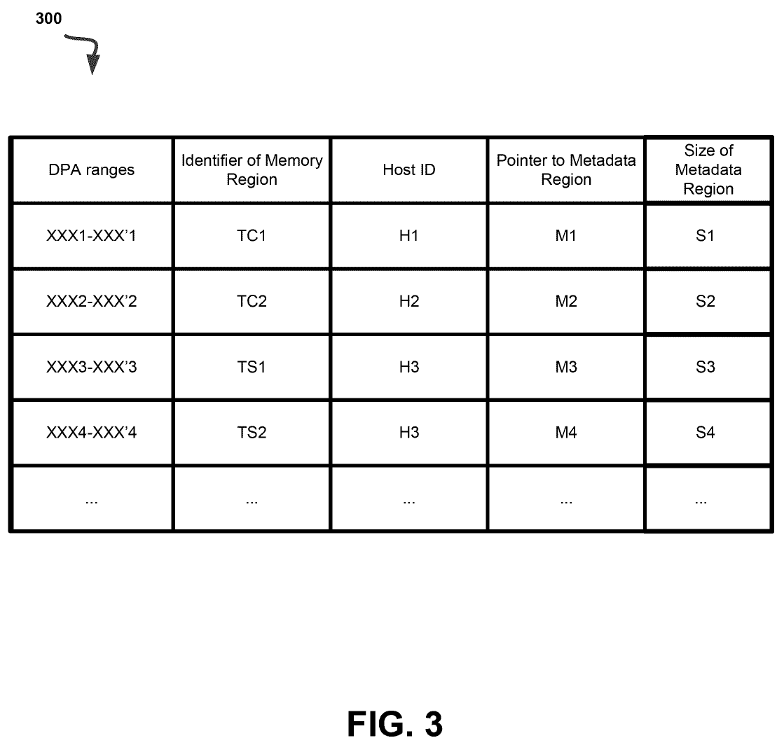

FIG. 3 illustrates an example of data structure 300 (e.g., the data structure 217 of FIG. 2) referencing a namespace accessible to a host system and to a set of dynamic capacity devices, in accordance with some embodiments of the present disclosure. In some implementations, the data structure 300 can be maintained by the fabric manager (e.g., the fabric manager 240 of FIG. 2). The data structure can be stored in the memory device (e.g., the CXL memory device 210 of FIG. 2). The data structure 300 can include an item “DPA ranges,” an item “identifier of memory region,” an item “host ID,” an item “pointer to metadata region” (e.g., “identifier of metadata region”), and/or an item “size of metadata region.” The item “DPA ranges” indicates the locations (e.g., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “identifier of memory region” indicates the identifier associated with the tagged capacity unit. The item “host ID” indicates the host system to which the tagged capacity unit associated with the identifier can be accessed. The item “pointer to metadata region” can identify a pointer to the starting address of the location (e.g., one or more physical ranges of the CXL memory device) storing metadata associated with the tagged capacity unit. In some embodiments, the starting address can be a header structure, which can store data pertaining to the metadata, such as a size (e.g., a number of bytes) of the metadata, a data type of the metadata, and/or a purpose of the metadata. The item “size of metadata region” can indicate a size (e.g., a number of bytes) of the metadata associated with the tagged capacity unit.

In view of the item “DPA ranges,” an item “identifier of memory region,” an item “host ID,” and an item “pointer to metadata region,” the data structure 300 can be used to map the DPA ranges to the host system by mapping the physical address ranges of the identifier to corresponding virtual address ranges in a virtual address space of the host system (i.e., the virtual/logical address space allocated by a host system to a host application that is permitted to access the data). The data structure 300 can also be used to map the DPA ranges to the metadata region by mapping the physical address ranges of the identifier of the tagged capacity unit to corresponding physical address ranges of the pointer to the metadata region.

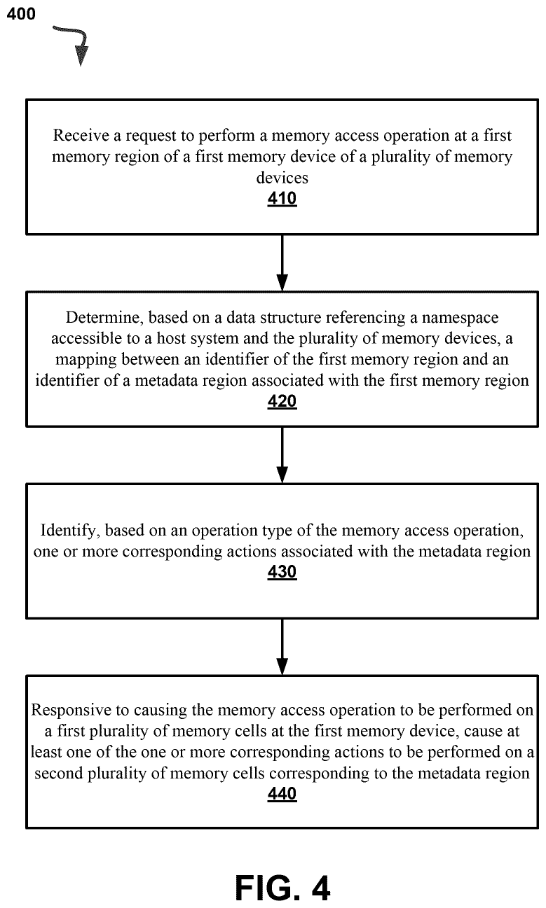

FIG. 4 is a flow diagram of an example method 400 for managing updates to metadata associated with memory access operations in a memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the metadata management component 113 of FIG. 1. In some implementations, the metadata management component 113 includes a command component 113A and a command component 113B as shown in FIG. 2, which can operate together to perform the functionality of the metadata management component 113. In some implementations, some or all of the functionalities of the metadata management component 113 can be performed by the fabric manager 240, the controller 215, the command component 113A, the command component 113B, and/or the combination thereof, as shown in FIG. 2. As described with respect to FIG. 1, the fabric manager can be software running on the host system 120, firmware embedded within a Baseboard Management Controller (BMC) of a distributed application, or a dedicated device running in the CXL device. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives a request to perform a memory access operation. In some embodiments, the memory access operation can refer to a read operation and/or a write operation. The processing logic can receive the request from a host system (e.g., a host system 220A-220D of FIG. 2). In some embodiments, the request can include an identifier of a memory region (e.g., a first memory region) (e.g., regions 236A, 236B, 236C, 236D of FIG. 2) of a dynamic capacity device (e.g., a first dynamic capacity device) of a set of dynamic capacity devices (e.g., DCD 230A, 230B, 230C, 230D of FIG. 2). In some implementations, each of the set of dynamic capacity devices includes a set of memory regions, where each memory region of the set of memory regions is associated with a respective identifier of a set of identifiers. Each of the sets of identifiers can be unique. In some implementations, the identifier is shared by the host system and another host system. In some implementations, the capacity of the memory region associated with the identifier is immutable. In some implementations, each memory region of the set of memory regions is associated with a respective identifier of an associated metadata region. Each associated metadata region can store metadata, including heat maps, temporal prefetch history, and other statistics for the memory region. In some embodiments, each of the set of dynamic capacity devices and the host system are connected with a set of CXL links. In some implementations, the memory region is accessible by the host system, and another (e.g., a second) memory region is accessible by another (e.g., a second) host system. In some implementations, the memory region is exclusively accessible by the host system, and the second memory section is exclusively accessible by the second host system.

At operation 420, the processing logic determines a mapping between an identifier of the memory region (e.g., the first memory region) and an identifier of a metadata region associated with the first memory region. In some embodiments, to determine the mapping between the identifier of the first memory region and the identifier of the metadata region associated with the first memory region, the processing logic uses a mapping data structure (e.g., the data structure 217 of FIG. 2 and/or the data structure 300 of FIG. 3) that is accessible to the host system and to the set of dynamic capacity devices. In some implementations, the data structure can be maintained by the fabric manager (e.g., the fabric manager 240 of FIG. 2). The data structure can be stored in the memory device (e.g., the CXL memory device 210 of FIG. 2). In some embodiments, the data structure can include a set of entries. Each entry can include an identifier of a memory region of a dynamic capacity device, an identifier of a corresponding range of physical addresses of the dynamic capacity device, a pointer referencing a physical location on the dynamic capacity device of a metadata region associated with the memory region, and/or an identifier of one or more host systems of a set of host systems (e.g., the host systems 220A-220D of FIG. 2), where the memory region is accessible by the one or more host systems. The pointer can be used as a base physical address of the metadata region. In some implementations, the fabric manager can configure the mapping between the identifier of the memory region and the pointer referencing the physical location of the metadata region. In some implementations, the fabric manager can configure a read-only access privilege of the metadata region to the one or more host systems. In some implementations, the fabric manager can configure shared access between the one or more host systems and the memory region (e.g., whether multiple host systems can share access to the memory region, or whether a single host system has exclusive access to the memory region). In some implementations, the fabric manager can configure an access privilege of each host system to the memory region (e.g., whether a host system can access the memory region). In some implementations, the fabric manager can configure the shared access and/or the access privilege using an application programming interface (API) of an orchestrator.

In some embodiment, in response to identifying the pointer referencing the physical location of the metadata region associated with the first memory region, the processing logic can determine a physical address that corresponds to the physical location of the metadata region. The processing logic can use the pointer as a base physical address of the metadata region.

At operation 430, the processing logic identifies one or more actions associated with the metadata region. In some implementations, to identify the one or more actions associated with the metadata region, the processing logic identifies an operation type of the memory access operation requested by the host system. For example, the operation type can include a read operation, a write operation, etc. Identifying the one or more actions to perform can include identifying a mapping between the operation type and the one or more actions, where the mapping is stored in an entry of a data structure (e.g., a second data structure and/or the data structure 217 of FIG. 2 and/or the data structure 300 of FIG. 3). In some implementations, an operation type that is a “read operation” can be mapped to at least the following one or more actions: a move operation, a copy operation, a reset operation, a clone operation, etc.

In some embodiments, a move operation can include moving metadata of a metadata region from a first physical location to a second physical location. In some embodiments, the move operation can be in response to performing the read operation, where performing the read operation includes moving data from the first memory region to another (e.g., a second) memory region. In some implementations, the first physical location is the physical address at which the metadata resides in the metadata region associated with the first memory region. As described above, the physical address can be determined using the data structure referencing the namespace that is accessible to the host system and to the set of dynamic capacity devices, where an entry of the data structure can include a mapping between an identifier of the first memory region and a pointer to the associated metadata region. The processing logic can identify the physical address by using the pointer, where the pointer references the base physical address of the metadata region. In some implementations, the second physical location is the physical address associated with a metadata region associated with the second memory region. The processing logic can determine the physical address using the data structure referencing the namespace, where another entry of the data structure can include a mapping between an identifier of the second memory region and a pointer to the associated metadata region. The processing logic can identify the physical address by using the pointer as the base physical address of the metadata region.

In some embodiments, a copy operation can include copying at least a portion of the metadata of the metadata region to another physical location. In some embodiments, the copy operation can be in response to performing the read operation, where performing the read operation includes copying data from the first memory region to another (e.g., a second) memory region. In some implementations, the first physical location is the physical address at which the metadata resides in the metadata region associated with the first memory region. As described above, the physical address can be determined using the data structure referencing the namespace that is accessible to the host system and to the set of dynamic capacity devices, where an entry of the data structure can include a mapping between an identifier of the first memory region and a pointer to the associated metadata region. The processing logic can identify the physical address by using the pointer as the base physical address of the metadata region. In some implementations, the second physical location is the physical address associated with a metadata region associated with the second memory region. The processing logic can determine the physical address using the data structure referencing the namespace, where another entry of the data structure can include a mapping between an identifier of the second memory region and a pointer to the associated metadata region. The processing logic can identify the physical address by using the pointer as the base physical address of the metadata region.

In some embodiments, a reset operation can include resetting at least a portion of the metadata of the metadata region. Resetting at least the portion of the metadata can include identifying the physical address at which the metadata resides in the metadata region associated with the first memory region. As described above, the physical address can be determined using the data structure referencing the namespace that is accessible to the host system and to the set of dynamic capacity devices, where an entry of the data structure can include a mapping between an identifier of the first memory region and a pointer to the associated metadata region. The processing logic can identify the physical address by using the pointer as the base physical address of the metadata region. The processing logic can assign a value of “zero” to the data (e.g., the set of memory cells) addressable by the physical address.

In some embodiments, a clone operation can include duplicating at least a portion of the metadata of the metadata region. In some embodiments, the clone operation can be in response to performing the read operation, where performing the read operation includes copying data from the first memory region to another (e.g., a second) memory region. In some implementations, the first physical location is the physical address at which the metadata resides in the metadata region associated with the first memory region. As described above, the physical address can be determined using the data structure referencing the namespace that is accessible to the host system and to the set of dynamic capacity devices, where an entry of the data structure can include a mapping between an identifier of the first memory region and a pointer to the associated metadata region. The processing logic can identify the physical address by using the pointer as the base physical address of the metadata region. In some implementations, the second physical location is the physical address associated with a metadata region associated with the second memory region. The processing logic can determine the physical address using the data structure referencing the namespace, where another entry of the data structure can include a mapping between an identifier of the second memory region and a pointer to the associated metadata region. The processing logic can identify the physical address by using the pointer as the base physical address of the metadata region.

In some implementations, an operation type that is a “write operation” can be mapped to at least the following one or more actions: a move operation to move metadata of a metadata region from a first physical location to a second physical location, as described above, a copy operation to copy at least a portion of the metadata of the metadata region to another physical location, as described above, a reset operation to reset at least a portion of the metadata of the metadata region, as described above, a clone operation to duplicate at least a portion of the metadata of the metadata region, as described above, a computation operation, etc.

In some embodiments, a computation operation can include performing a computation operation on at least a portion of the metadata of the metadata region. The computation operation can be any computation operation. For example, the computation operation can include an additive operation, a division operation, a multiplication operation, etc. In some embodiments, the clone operation can be in response to performing the write operation, where performing the write operation includes performing a computation to the data of the first memory region. In some implementations, the processing logic can identify the physical address of the portion of the metadata, where the physical address can be determined using the data structure referencing the namespace, and where an entry of the data structure can include a mapping between an identifier of the first memory region and a pointer to the associated metadata region. The processing logic can identify the physical address by using the pointer as the base physical address of the metadata region. The processing logic can perform the computation operation to the data (e.g., the set of memory cells) addressable by the physical address.

At operation 440, the processing logic causes at least one of the one or more actions identified at operation 430 to be performed on a set of memory cells that are addressable by a physical address and/or a range of physical addresses storing the metadata at the dynamic capacity device. In some implementations, causing the at least one of the one or more actions to be performed can be in response to performing the memory access operation requested at operation 410. In some implementations, causing the at least one of the one or more actions to be performed includes sending a request to perform the at least one of the one or more actions to the dynamic capacity device to be performed at the identified physical address. For example, the at least one of the one or more actions to be performed can include performing a move operation to move metadata of the metadata region from the identified physical address to another physical address, a copy operation to copy at least a portion of the metadata of the metadata region to another physical address, a reset operation to reset at least a portion of the metadata of the metadata region to zero, a clone operation to duplicate at least a portion of the metadata of the metadata region, a computation operation to perform a computation operation on at least a portion of the metadata of the metadata region. In some embodiments, the computation operation can be any computation operation. For example, the computation operation can include an additive operation, a division operation, a multiplication operation, etc.

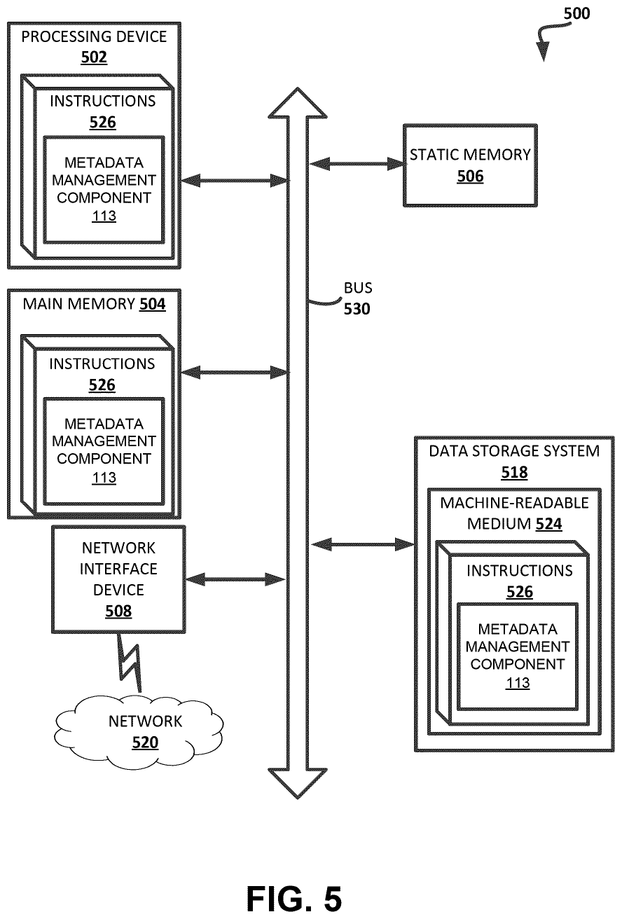

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the I/O operation management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the metadata management component 113 of FIG. 1 and method 400 of FIG. 4. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of memory devices; and
a processing device, operatively coupled with the plurality of memory devices, to perform operations comprising:
receiving a request to perform a memory access operation at a first memory region of a first memory device of the plurality of memory devices;
determining, based on a data structure referencing a namespace accessible to a host system and to the plurality of memory devices, a mapping between an identifier of the first memory region and an identifier of a metadata region associated with the first memory region;
identifying, based on an operation type of the memory access operation, one or more corresponding actions associated with the metadata region;
causing the memory access operation to be performed on a first plurality of memory cells at the first memory device; and
responsive to causing the memory access operation to be performed, causing at least one of the one or more corresponding actions to be performed on a second plurality of memory cells corresponding to the metadata region.

2. The system of claim 1, wherein each of the plurality of memory devices is a dynamic capacity device connected to the host system via a respective plurality of Compute Express Link (CXL) links.

3. The system of claim 1, wherein the data structure comprises a plurality of entries, wherein each entry comprises an identifier of a memory region, a pointer referencing a physical location of a metadata region associated with the memory region, an identifier of a corresponding range of physical addresses of sets of memory cells residing on the plurality of memory devices, and an identifier of one or more host systems of a plurality of host systems, wherein the memory region is accessible by the one or more host systems.

4. The system of claim 1, wherein the operations further comprise:
identifying, based on the data structure referencing the namespace, a first pointer referencing a first physical location of the metadata region associated with the first memory region.

5. The system of claim 1, wherein the one or more actions associated with the metadata region comprise at least one of: (i) a move operation to move metadata of the metadata region from a first physical location to a second physical location, (ii) a copy operation to copy at least a portion of the metadata of the metadata region, (iii) a reset operation to reset at least the portion of the metadata of the metadata region, (iv) a clone operation to duplicate at least the portion of the metadata of the metadata region, or (v) a computation operation to perform a computation operation to at least the portion of the metadata of the metadata region.

6. The system of claim 1, wherein the metadata region associated with the first memory region is associated with a read-only access privilege to the host system.

7. The system of claim 1, wherein the system further comprises a fabric management component, wherein the fabric management component comprises firmware embedded within a baseboard management controller, and wherein the fabric management component associated with the one or more of the plurality of memory devices creates, via an application programming interface, an entry of the data structure, wherein the entry comprises the mapping between the identifier of the first memory region and the identifier of the metadata region associated with the first memory region.

8. A non-transitory computer-readable storage medium comprising instructions that, when executed by a processing device, cause the processing device to perform operations comprising:
receiving a request to perform a memory access operation at a first memory region of a first memory device of a plurality of memory devices;
determining, based on a data structure referencing a namespace accessible to a host system and to the plurality of memory devices, a mapping between an identifier of the first memory region and an identifier of a metadata region associated with the first memory region;
identifying, based on an operation type of the memory access operation, one or more corresponding actions associated with the metadata region;
causing the memory access operation to be performed on a first plurality of memory cells at the first memory device; and
responsive to causing the memory access operation to be performed, causing at least one of the one or more corresponding actions to be performed on a second plurality of memory cells corresponding to the metadata region.

9. The non-transitory computer-readable storage medium of claim 8, wherein each of the plurality of memory devices is a dynamic capacity device connected to the host system via a respective plurality of Compute Express Link (CXL) links.

10. The non-transitory computer-readable storage medium of claim 8, wherein the data structure comprises a plurality of entries, wherein each entry comprises an identifier of a memory region, a pointer referencing a physical location of a metadata region associated with the memory region, an identifier of a corresponding range of physical addresses of sets of memory cells residing on the plurality of memory devices, and an identifier of one or more host systems of a plurality of host systems, wherein the memory region is accessible by the one or more host systems.

11. The non-transitory computer-readable storage medium of claim 8, wherein the operations further comprise:
identifying, based on the data structure referencing the namespace, a first pointer referencing a first physical location of the metadata region associated with the first memory region.

12. The non-transitory computer-readable storage medium of claim 8, wherein the one or more actions associated with the metadata region comprise at least one of: (i) a move operation to move metadata of the metadata region from a first physical location to a second physical location, (ii) a copy operation to copy at least a portion of the metadata of the metadata region, (iii) a reset operation to reset at least the portion of the metadata of the metadata region, (iv) a clone operation to duplicate at least the portion of the metadata of the metadata region, or (v) a computation operation to perform a computation operation to at least the portion of the metadata of the metadata region.

13. The non-transitory computer-readable storage medium of claim 8, wherein the metadata region associated with the first memory region is associated with a read-only access privilege to the host system.

14. The non-transitory computer-readable storage medium of claim 8, wherein a fabric management component associated with the one or more of the plurality of memory devices creates, via an application programming interface, an entry of the data structure, wherein the entry comprises the mapping between the identifier of the first memory region and the identifier of the metadata region associated with the first memory region.

15. A method, comprising:
receiving, by a processing device, a request to perform a memory access operation at a first memory region of a first memory device of a plurality of memory devices;
determining, based on a data structure referencing a namespace accessible to a host system and to the plurality of memory devices, a mapping between an identifier of the first memory region and an identifier of a metadata region associated with the first memory region;
identifying, based on an operation type of the memory access operation, one or more corresponding actions associated with the metadata region;
causing the memory access operation to be performed on a first plurality of memory cells at the first memory device; and
responsive to causing the memory access operation to be performed, causing at least one of the one or more corresponding actions to be performed on a second plurality of memory cells corresponding to the metadata region.

16. The method of claim 15, wherein each of the plurality of memory devices is a dynamic capacity device connected to the host system via a respective plurality of Compute Express Link (CXL) links.

17. The method of claim 15, wherein the data structure comprises a plurality of entries, wherein each entry comprises an identifier of a memory region, a pointer referencing a physical location of a metadata region associated with the memory region, an identifier of a corresponding range of physical addresses of sets of memory cells residing on the plurality of memory devices, and an identifier of one or more host systems of a plurality of host systems, wherein the memory region is accessible by the one or more host systems.

18. The method of claim 15, further comprising:
identifying, based on the data structure referencing the namespace, a first pointer referencing a first physical location of the metadata region associated with the first memory region.

19. The method of claim 15, wherein the one or more actions associated with the metadata region comprise at least one of: (i) a move operation to move metadata of the metadata region from a first physical location to a second physical location, (ii) a copy operation to copy at least a portion of the metadata of the metadata region, (iii) a reset operation to reset at least the portion of the metadata of the metadata region, (iv) a clone operation to duplicate at least the portion of the metadata of the metadata region, or (v) a computation operation to perform a computation operation to at least the portion of the metadata of the metadata region.

20. The method of claim 15, wherein the metadata region associated with the first memory region is associated with a read-only access privilege to the host system.
